(19) United States
(12) Patent Application Publication
(10) Pub. No.: US 2001/0037223 A1
(43) Pub. Date: Nov. 1, 2001

(54) Management and delivery of product information

(76) Inventors: Brian Beery, Milbury, MA (US); Daniel Silva, Rockland, MA (US); Linda Whitenack, Windham, NH (US); Didier Barnes-Guzman, Woburn, MA (US); Shelley Moore, Boston, MA (US); Timothy S. Farlow, Needham, MA (US); Yi Sun, Framingham, MA (US); Jamie Fernandes, Roslindale, MA (US)

Correspondence Address: DAVID L. FEIGENBAUM, Fish & Richardson P.C., 225 Franklin Street, Boston, MA, 02110-2804, US

(21) Appl. No.: 09/757,376

(22) Filed: Jan. 9, 2001

Related U.S. Application Data
(63) Continuation-in-part of application No. 09/375,626, filed on Aug. 17, 1999.
(63) Continuation-in-part of application No. 09/502,565, filed on Feb. 11, 2000.
(63) Continuation-in-part of application No. 09/244,451, filed on Feb. 4, 1999.

(51) Int. Cl. G06F 17/60

(52) U.S. Cl. 705/4

(57) ABSTRACT

Among other things, a method that includes (1) enabling an insurance carrier to create and maintain, on a server, product information that characterizes insurance products that are distributed by the insurance carrier through an employer to employees, (2) enabling retrieval at the server of employee information about the employees that is under control of the employer, and (3) enabling employees who are members with respect to the products of the insurance carrier to access the server to obtain answers to questions based on the product information and the employee information.

### BACKGROUND

This invention relates to management and delivery of product information.

A health insurance policy, for example, is a product that may represent an obligation by the insurance carrier to pay benefits to an individual policyholder when he gets sick. The policy may place conditions on the payment of the benefits, for example, based on when the illness occurred relative to the policy period or the nature of the illness. The policy may also require a co-payment by the insured, or the policy may only pay a percentage of the costs of the covered illness.

Health insurance products are offered by a large number of insurance carriers and health maintenance organizations (HMOs). Typically, the products are not sold directly to the individuals who are to be covered (the members) but rather are marketed through a chain of distribution (a supply chain) that includes the carriers, insurance agents (who act as wholesalers), brokers, and employers of the individuals to be covered. The employers often play a role as aggregators in making available to their employees (the members) a choice among health insurance products either from a single carrier or from several carriers.

Nearly all health insurance products share common attributes in terms of eligibility to become a member, benefits provided, and the conditions that determine the existence and level of coverage in a given instance. Yet there are differences among the many thousands of specific health plans that are offered through different employers to their employees.

Because the features of health insurance products are complicated, an employer who offers health insurance products to its employees incurs a substantial burden in answering questions and providing information to its employees about the plans. The burden arises not only when the employee is presented with a choice among plans but also during the course of the policy period, for example, when the employee gets sick or is injured. On the latter occasions, the answers can be focused on the specific facts of the case and the specific situation of the employee.

Employers meet their burden of providing information and answers by a variety of techniques including distribution of printed plan descriptions and plan summaries and by making specially trained staff available to their employees. Information may also be provided on-line, for example, through the employer's internal website.

Parties that are further up the supply chain, such as brokers, agents, and carriers may also provide materials, computer programs, and on-line information for the employer to use in providing information and answers to its employees.

Similar scenarios exist with respect to a variety of other products that represent conditional obligations to individuals, such as other insurance products and benefits provided to employers and benefits and other obligations of governments to their citizens, or universities to their students, or unions to their members.

### SUMMARY

Although references are made throughout this patent to employers and their employees, the invention is applicable to situations in which the customers of the carrier's products are individuals and where there is no employer involved directly in the transaction. The employees and the individuals in the different scenarios may all be referred to as members with respect to the carrier's products.

References are also made to systems that store information about employees, including legacy systems under the control of employers. Those references also apply to situations in which the members are individuals and in either case, the information may be maintained by the carrier, e.g., in legacy systems, rather than by the employer, or by a cooperative effort of the carrier and the employer.

In a similar vein, although the text refers frequently to insurance carriers, the invention is also applicable to other product suppliers including, more generally, benefit providers or financial services providers. The discussion with respect to insurance carriers is meant as an example and not meant to limit the scope of the invention.

In general, in one aspect, the invention features a method that includes (1) enabling an insurance carrier to create and maintain, on a server, product information that characterizes insurance products that are distributed by the insurance carrier to individual members (for example, through an employer to employees), (2) enabling retrieval at the server of information about the employees or members that is under control of the employer or the carrier, and (3) enabling the individuals who are members with respect to the products of the insurance carrier to access the server to obtain answers to questions based on the product information and the member information. Implementations of the invention may include one or more of the following features. The server is hosted by a party other than the insurance carrier. Access to the server by the employees is through web browsers and a TCP/IP network. The insurance carrier creates and maintains the product information through web browsers and a TCP/IP network. The carrier is in control of carrier specific content information and plan details stored on the server. The product information includes “if, then” rules that define general characteristics of the product and parameter values that render the rules specific to respective products. The enabling of the insurance carrier to create and maintain the product information includes providing an interactive interface that prompts the carrier for parameter values required by product templates. The enabling of the employees to access the server includes providing an interactive interface that enables the employees to express questions and have answers displayed. The answers include information useful to the employee in making a choice among different insurance products. The answers include information useful to the employee in determining the availability of coverage in a particular situation. The questions are expressed in standardized formats and the answers are provided in standardized formats. The questions comprise keywords and the answers comprise the results of using the keywords to search stored information accessible through the server. The stored information about the employees includes demographic information.

In general, in another aspect, the invention features a method that includes, (a) during a development phase, creating and storing template information that characterizes types of insurance products, (b) during a publication phase, pre-processing the template information to create a published body of information about the types of insurance products and storing the published body of information in a server, the published body of information being configured to require less processing than the template information to respond to questions, and (c) during a run-time phase, applying questions received at the server about the insurance products to the published body of information to generate answers to the questions.

Implementations of the invention may include one or more of the following features. The questions received at the server relate to coverage of the insurance products with respect to particular situations of individuals who are members with respect to the products. The answers are generated with reference to stored information about particular individuals who are members with respect to the insurance products.

In general, in another aspect, the invention features a medium on which is stored a machine-readable representation of a product, the product including conditional obligations of one party to another. The representation of the product is stored in accordance with a standardized format for expression of characteristics of the product. The characteristics include conditions under which a party would be eligible to obtain the product and conditions under which a party that has obtained the product is entitled to receive the benefit of the obligations included in the product. The representation of the product implying an interface that enables applications to create, maintain, and access the representation of the product for predefined purposes.

Implementations of the invention may include one or more of the following features. The obligations included in the product comprise benefits for individuals. The benefits comprise insurance benefits. The obligations comprise coverage obligations of an insurance carrier, and the party to whom the obligations are owed includes employees of an employer that offers the product of the carrier to the employees. The representation of the product comprises a general representation for a class of products and the conditions are defined in terms of variables. Representations of other products that include obligations of one party to another are also stored. Representations of products of competing parties are also stored, each of the products including obligations of one party to another, all of the representations being stored in accordance with the standardized format for expression of characteristics of the product.

In general, in another aspect, the invention features a method that includes (1) enabling parties that belong to a supply chain for products to create product definitions for each of the products in accordance with a standardized product-definition format, the products being of a kind that encompass conditional obligations of suppliers of the products, (2) enabling each of the parties that create product definitions to store the product definitions in a manner that makes them accessible to at least one of the other parties in the supply chain, and (3) giving access to at least one of the parties in the supply chain to the stored product definitions in connection with a commercial transaction.

Implementations of the invention may include one or more of the following features. The conditional obligations comprise benefits to which individual members are entitled under insurance products upon the occurrence of predefined conditions, and the parties that belong to the supply chain include carriers and employers. The standardized product-definition format associates benefits with conditions that trigger entitlement to the benefits. The standardized product-definition format associates the product with conditions on the availability of the product to potential members. The product definitions are stored on a common server that is accessible to the parties in the supply chain through a public network. Information about the products is generated for use by parties that belong to the supply chain using the stored product definitions. The generated information is configured based on the party that will be using it. Parties that are not in the supply chain are given access to information derived from the product definitions. The parties are end users of the products. One of the parties in the supply chain makes a commercial proposal to another of the parties in the supply chain with respect to one of the products by referring to the stored definition of the product. The proposal comprises a request for proposals, a request for information, or a reply to a request for proposals or to a request for information. One of the parties in the supply chain is enabled to provide automated answers and information about the product to end customers of the product using the stored product definitions.

In general, in another aspect, the invention features a method that includes (1) from a server, enabling an employee of an employer to get answers to questions that relate to characteristics of an insurance product of a carrier with respect to which the employee is or may become a member, (2) analyzing the employee's interaction with the server, based on the analysis and on information known to the employer about the employee, (3) determining other insurance products of the carrier that may be of interest to the employee, and (d) providing information about the other products to the employee in conjunction with providing answers to the questions of the employee.

Implementations of the invention may include one or more of the following features. Information about the product and the other products is stored on the server in a standardized format, and the stored information is queried to generate the answers to the questions. The carrier is enabled to store the information about the products and other products in the server without intervention by the employer. The information known to the employer about the employee is accessed by the server from a legacy system of the employer. Information about members who may not be employees could be accessed from a carrier legacy system.

In general, in another aspect, the invention features a system that includes (1) a knowledgebase of information about products that represent conditional obligations of a supplier of the products, (b) an evaluation layer that evaluates information in the knowledgebase in response to requests from a presentation layer, the presentation layer being configured to respond to queries received from a publicly accessible communication network, and (c) a components layer configured to manage sessions with users from whom the queries are received.

Implementations of the invention may include one or more of the following features. The presentation layer is configured to compose and serve web pages in response to the queries, based on the evaluation performed by the evaluation layer. The presentation layer is configured apply security measures. The presentation layer communicates with the evaluation layer using XML over java beans. The evaluation layer is also configured to search a database based on the query. The components layer is also configured to perform logging, statistics, and audit functions. The components layer is also configured to provide a bridge to a legacy database of information about users. The components layer comprises software components. The evaluation layer comprises a run-time interpreter.

In general, in another aspect, the invention features a system that includes (1) access to a legacy health care information system, and (2) enhancements to the legacy health care information system that (a) enable an insurance carrier to create and maintain product information that characterizes insurance products that are distributed by the insurance carrier through the employer to employees, (b) enable retrieval of employee information about the employees from the legacy system, and (c) enable employees who are members with respect to the products of the insurance carrier to obtain answers to questions based on the product information and the employee information.

In general, in another aspect, the invention features a system that includes (1) a web portal that makes health care information available to the public through the Internet, and (2) enhancements to the web portal that (a) enable an insurance carrier to create and maintain product information that characterizes insurance products that are distributed by the insurance carrier and (b) enable employees who are members with respect to the products of the insurance carrier to obtain answers to questions based on the product information.

Among the advantages of the invention are one or more of the following.

Customer service representatives can deliver immediate, accurate, personalized answers to customer questions about, for example, insurance coverage and plan details. Subject matter experts in a service center may share their expertise across customer service representatives so that questions may be answered on a first call. Customers may find answers that apply uniquely to them, through any Web-browser, at any time of day. The plan and product information may be created, distributed, and maintained quickly and easily.

Taking insurance carriers only as an example, carriers can easily communicate with their insured populations using the system. Carriers may create, integrate, disseminate, and maintain plan and product information quickly and easily. Carriers may improve service levels, reduce administrative costs, and differentiate themselves from competitors. The system is available on a subscription basis over the Internet. Carriers can enter data about the plans they offer and, when integrated with demographic and eligibility information, provide users with detailed plan descriptions tailored to the role of the user and specific to the individual member.

The system can be extended to insurance markets other than healthcare (e.g., life, short term disability, long term disability, and long term care).

The system is capable of performing a variety of functions. Personalized answers are dynamically generated upon request using a combination of core content, plan/employer data values, and indicative member data. The system can be operated on a subscription basis, enabling organizations and their members to access answers over the Internet through a Web-browser. A very large number of users can be supported without sacrificing performance. Data can be accepted from other enterprise systems to reduce duplicate data entry. The system can be integrated with call tracking applications and with transaction applications. The system collects information about how users interact with the application.

The system helps carriers, for example, to improve service and communication with members by offering online access to personalized information at any time, providing immediate answers tailored to specific member questions, supplying consistent, accurate answers, answering questions on the first call/inquiry, and decreasing answer-searching frustration.

The system helps to reduce call center costs and increase productivity by shortening the time to answer a question, reducing reliance on plan experts, decreasing the number of call backs, reducing CSR training requirements, lessening the impact of CSR turnover, decreasing member “answer shopping”, and reducing liability exposure.

The system helps carriers, for example, to decrease the costs of creating, disseminating, and maintaining plan information by reducing the time required to define a set of plans, decreasing the administrative burden of maintaining printed documents, tailoring standard content using simple question/answer format, implementing data changes and updates automatically, from a single edit, and providing immediate online access to the information.

The system enables carriers, for example, to support member self-service through the Web by enabling members to access plan and coverage information through a browser, extending access to information from call center to members through the Internet, providing the plan and coverage knowledge necessary to support Web-based transactions, supplementing content with external links, and integrating personalized plan and coverage information with existing Web communication initiatives.

The system enables carries, for example, to differentiate from competitors by providing better service and increased value to members and employers, increasing profitability through cost reductions, and providing insight on the plan preferences and buying patterns of members and employers.

The party that operates the system can generate revenue through subscription fees, sale of data to both carriers and employers (e.g., pre-populated plan definitions, plan design norms/benchmarks, employee/member characteristics and/or plan preferences) and transaction fees associated with cross-selling or referring members to other content sites.

Other advantages and features will become apparent from the following description and from the claims.

### DESCRIPTION

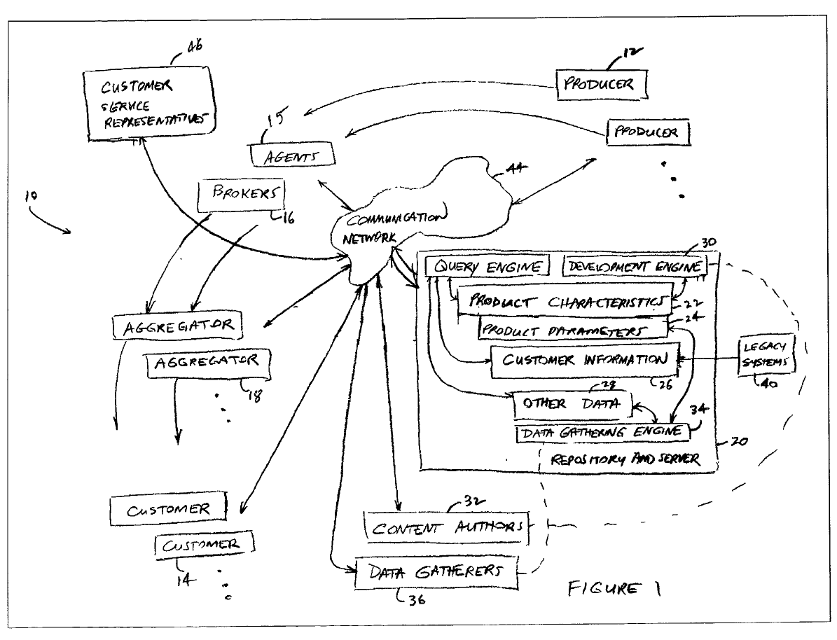

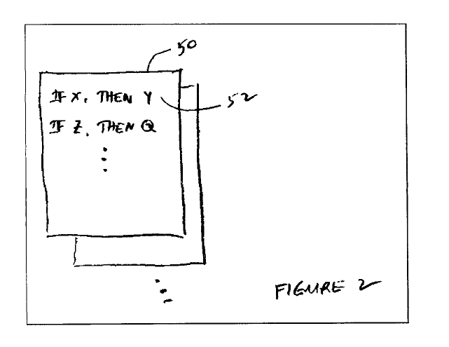

(FIG. 1 is a block diagram.

FIG. 2 shows product templates.

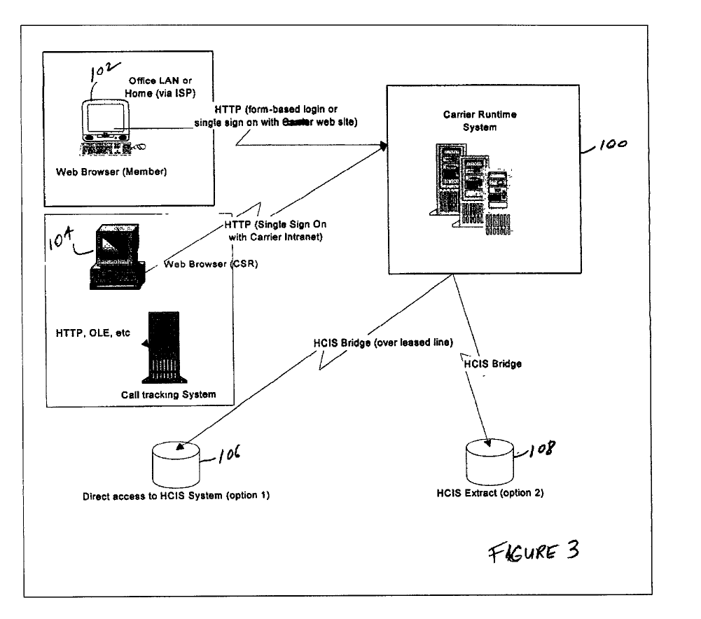

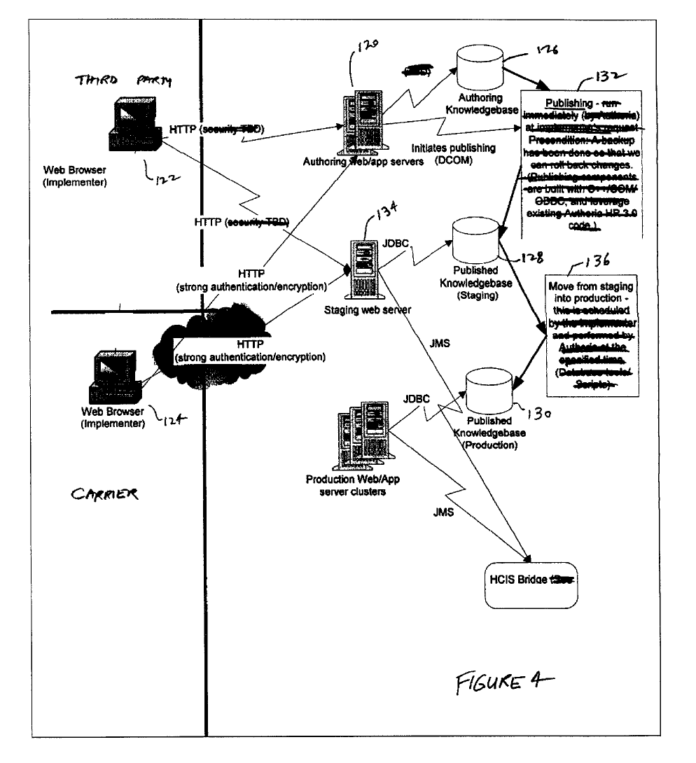

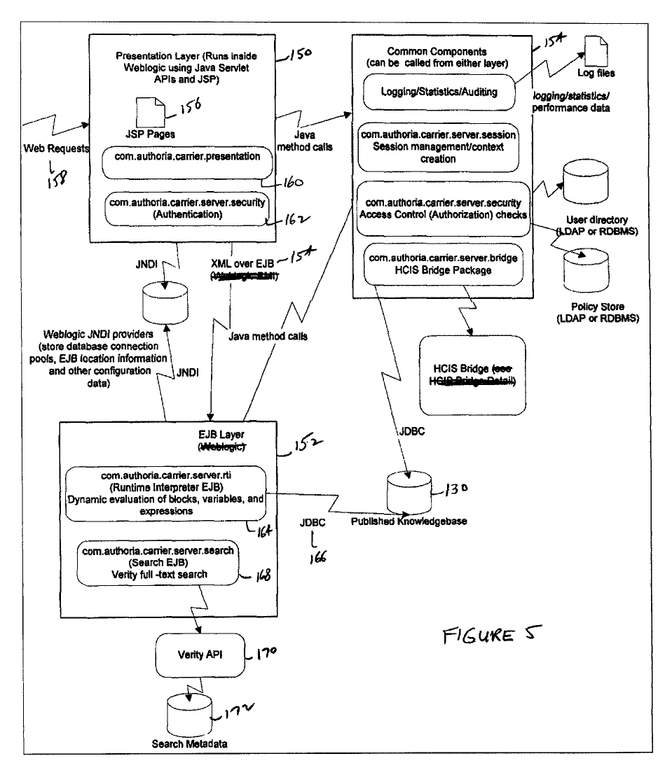

FIGS. 3 and 4 are flow diagrams.

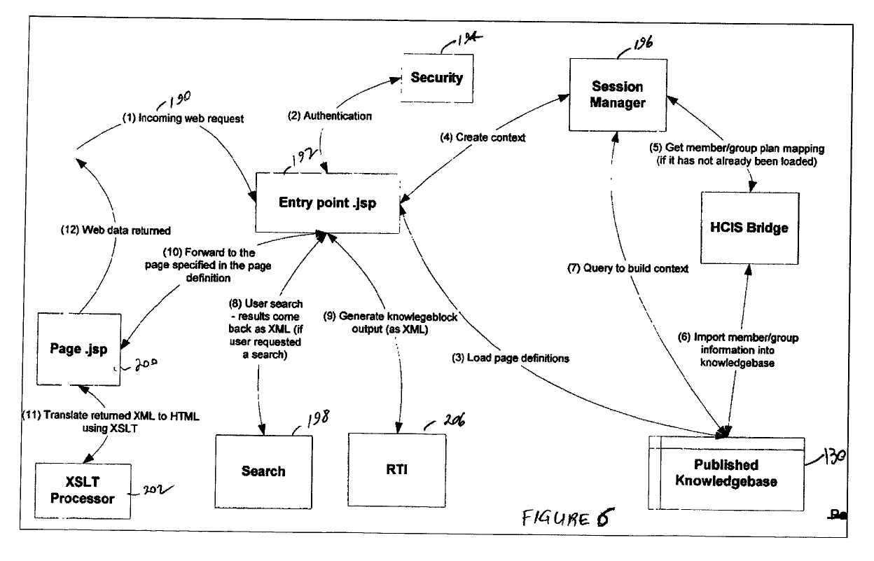

FIG. 5 shows a runtime architecture.

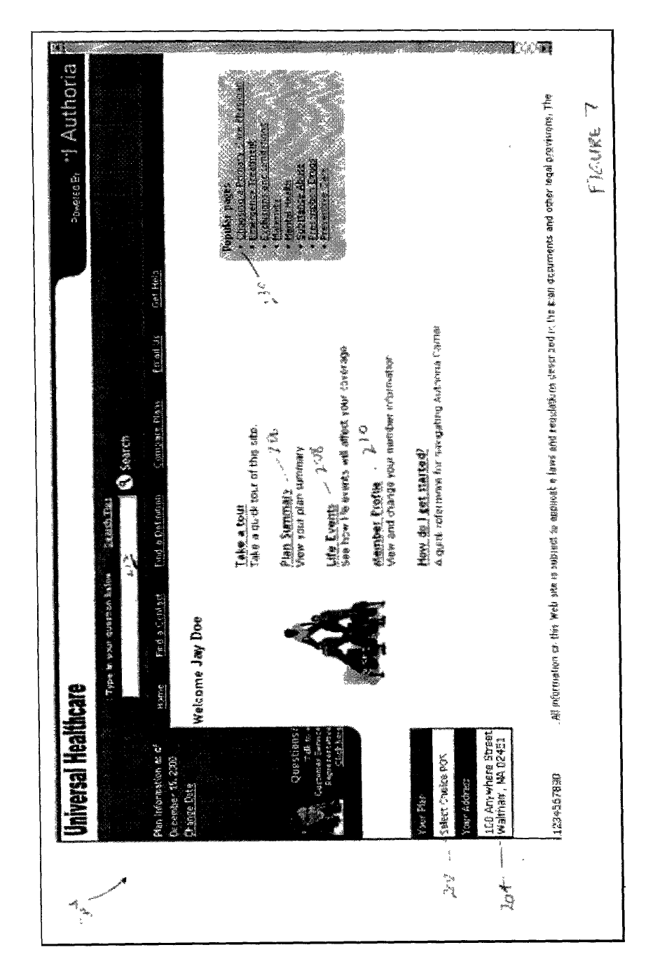

FIG. 6 is a process flow diagram.

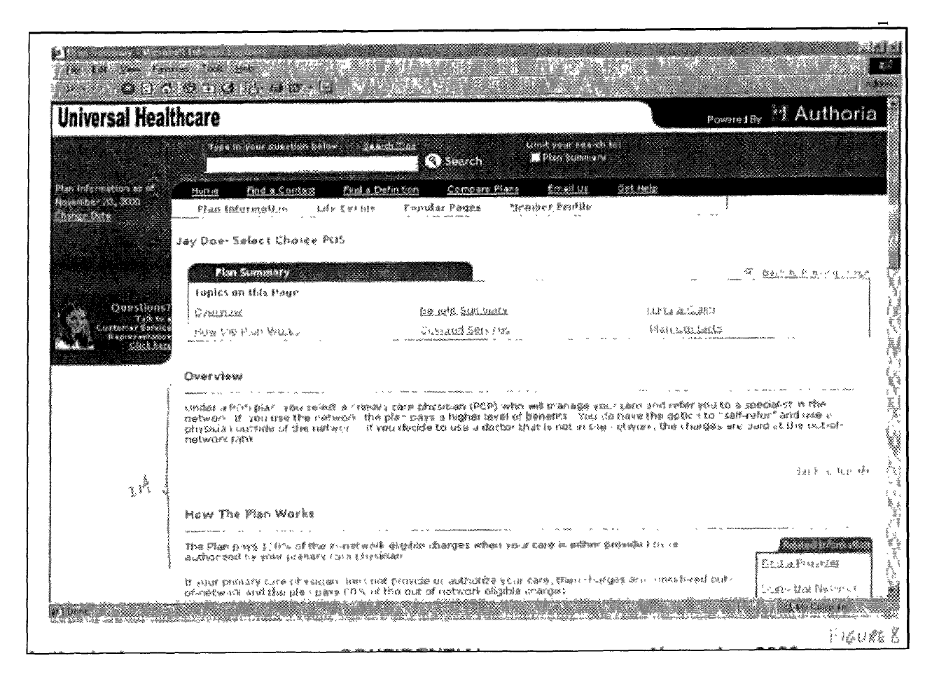

FIGS. 7 through 14 show web pages.

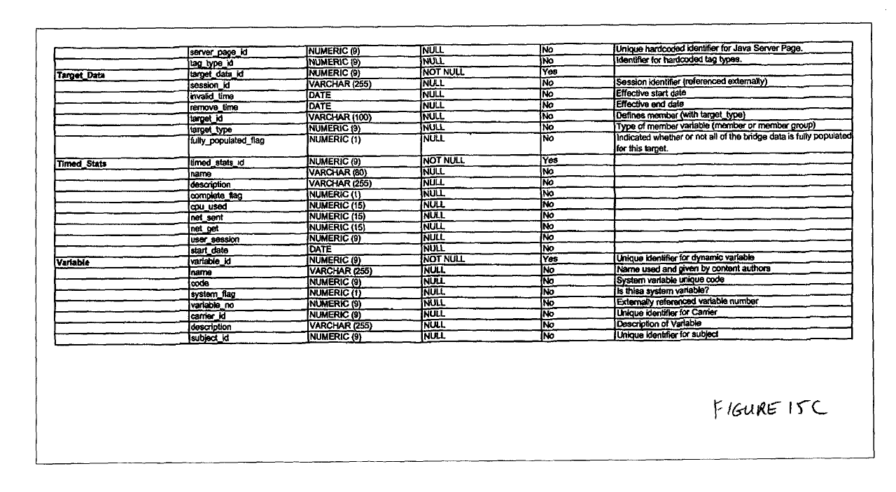

FIGS. 15A, 15B, and 15C show a data schema.)

As shown in FIG. 1, a supply chain 10 for products that represent conditional obligations by producers 12 to individual customers 14 can include agents 15 and brokers 16 that serve as intermediaries between the producers and aggregators 18. The aggregators make the products available to the customers 14.

A repository and server 20 persistently stores product characteristics 22, product parameters 24, customer information 26, and other data 28 that is useful in answering questions and providing information to the customers, producers, and other parties in the supply chain.

The repository and server 20 also include applications that assist in accumulating and managing, and answering questions based on, the stored information.

One of the applications is a development engine 30 that enables content authors 32 to interactively express, in a standardized product-definition format, generalized product characteristics for the products. This information is stored in the product characteristics 22.

Another application, a data gathering engine 34, enables data gatherers 36 to interactively provide product parameters that define specific products with reference to the generalized product characteristics of a class of products, and other data 28.

At least some of the customer information 26 may be derived from or accessed by links or bridges to legacy systems 40 owned by one of the parties in the supply chain, for example, the aggregator.

A query engine 46 responds to queries by invoking the product characteristics, the product parameters, the customer information, and the other data as needed.

Depending on the application, all of the parties in the supply chain can communicate with the repository and server through a communication network 44. Customer service representatives 46 associated with the aggregator or other parties in the supply chain may also communicate with the repository and server in the course of providing customer service by telephone or email or paper correspondence.

### CLASSES OF USERS

As implied in the previous discussion various classes of users can take advantage of and participate in the system.

Members/Consumers

Members are primary users of the system. Members or consumers access the system over the Internet using a web-browser at any time. A member is typically defined as a plan subscriber or any dependents covered by the subscriber's plan. Each member might use the system three to four times per year.

Members use the system to search for answers to questions about plan details and coverage. Members search for information using keywords and phrases that represent concepts that are meaningful to them. Members can also drill down through navigation trees to find the information that they need. Members can also reference information in the context of significant life events, for example having a baby, getting married, etc.

Members can navigate back and forth between the carrier's main web site, the system, and other content or transaction applications. They either login to the system directly or to one of the other applications. Regardless of where the member interaction originates only a single login is required, because the authentication schemes between applications are integrated.

Customer Service Representatives

CSRs use the system on a daily basis. CSRs access the system from inside a call center using a web browser. A CSR answers a phone call from a member and provides the member with plan details and coverage information pulled from the system.

CSRs access the system either directly or from within a call tracking application. A call tracking application is typically a software program that supports the workflow of the CSR and documents interaction with the member. CSRs can log an answer found in the system into the call tracking application as part of documenting interaction with the member.

CSRs navigate back and forth between the main carrier web site, the system, a call tracking application, a claims processing system, and potentially other enterprise applications.

Carrier/Payor Management

Management representatives of the carrier or the employer are secondary users of the system. Management is typically a group of users who manage member communication and services. These users are responsible for the distribution of information about the plans offered, servicing member requests through call centers or other infrastructure, and ensuring member satisfaction. Management represents departments known as member services, member communications, or member relations. Managers set up plans, modify core the system content, and add new content. They create reports that identify the most frequently asked questions and collect information about how members and CSRs interact with the system.

Outsourcers

Outsourcers are secondary users of the system. Outsourcers include companies that provide turn key member management services to healthcare insurers. Outsourcers take the place of traditional member services departments and are responsible for the distribution of information about the plans offered, servicing member requests, and ensuring member satisfaction. Outsourcers, particularly their CSRs, will use the system every day as part of their jobs.

Outsourcers are able to setup plans, modify core the system content, and add new content.

Implementers

Implementers are secondary users of the system. Implementers are users who implement the system for use by an employer. Implementers may be the party's carrier services staff or staff at the carrier organization. Implementers setup plans, modify core the system content, and potentially add new content. Implementers may use the system in an integrated context with other applications (e.g., call tracking, web sites, external content).

Content Developers

Content Developers are secondary users of the system. Content developers are responsible for authoring the system core content. They use the system tools to modify existing content, create new content, and maintain content as part of the product release cycle.

Content developers create new content and test it in a representative carrier environment. They preview or display content in web pages and print out reports to ensure that the rules, text, and variables in core content is working properly.

### GENERAL SYSTEM FEATURES

The system implements a range of functional features.

Generate Information about Benefit Plans

The system dynamically generates information about benefit plans offered by carriers upon request from a member or CSR. A request may take the form of either a search for keywords/concepts or navigation between the system web pages. The information will use a combination of plan information, member data, and the current date to create and display results that are accurate and personalized for the member.

Plan information and member eligibility may change on a daily basis. The system considers the current date in relation to member eligibility and effective dates associated with plan provisions, and displays only the information valid as of the date specified. The specified date will default to the current date of the request, but users may change the date from within the browser in order to see plan information as of a different date (e.g., historical or future plan provisions).

The information generated by the system in response to interaction by the user differs according to user role. Different users require different types of information displayed in different formats.

Information for Members

Members may access personalized plan information, a personal profile, and generic information about other plans offered by the carrier. The default view for members upon entry is either the system “member home page” or an alternate entry page designated by the carrier (e.g., an existing intranet or self service web site). The information is presented in language that is easily understood and tailored to a member audience.

Members may access information in the context of particular plans and in the context of life events.

When viewing personal information, members are restricted to data about themselves or other members associated with them (e.g., members related to a common subscriber such as a spouse, children, or other dependents).

The personal profile is a snapshot of the member's demographic and plan participation data. It includes information about the subscriber and any related dependents. The level of detail is determined by the degree of integration between the system and the carrier's backend systems.

Members may view generic plan descriptions for other plans offered by carrier. These descriptions do not contain any personalized information.

Information for CSRs

CSRs may access plan information tailored to a particular member or group of members. They also have access to generic plan descriptions.

The default view for CSRs upon entry is the system “CSR home page” or an alternate entry page designated by the carrier (e.g., an existing intranet or self service web site). In addition to standard search and navigation features on the entry page, the CSR may enter a member identification number, choose a member group, or choose a generic plan description.

The information is presented in a language and format that is tailored to a CSR audience. Typically, CSRs prefer abbreviated information and prioritize speed and ease of navigation over the web page quality (e.g., graphics, extra information, consumer-focus, etc.).

CSRs may also access member views of information directly from their own desktops.

Information for Providers

Providers may access generic plan descriptions and the plan and eligibility information for a particular member. The eligibility information may consist of an expanded member profile, which displays a member's personal profile plus the coverage details for a member's plan. The provider may use this information to determine if services will be paid for before they are delivered. He/she will also be able to determine if a referral or pre-certification is necessary prior to treatment and, if so, what process should be followed.

Member eligibility information is provided on a real time basis.

Creation and Maintenance of Benefit Plans

The system software and developed core content enables organizations to model benefit plans using a combination of rules and variables. Using the system software tools, content authors and carriers may populate variables present in the core content, customize existing rules and variables, and create new rules and variables.

Once a plan is modeled, it may be optionally associated with an employer or employer group. Content authors and carriers may choose to create new employers, populate employer variables, and modify existing employer characteristics.

Individual plans have a plan structure and data values, which populate variables in the structure. The system allows carriers to share plan structures, data values, or both data values across different employers. Sharing includes associating a single plan with many employers, employer groups, lines of business, or individual product lines. The ability to share reduces the total number of plans that must be defined and the effort necessary to maintain them.

Individual plans are often variations of a common plan structure. The system enables carriers to create a set of standard plan templates that may be used as a basis for individual plans. Templates have a predefined plan structure, but do not have all of the information necessary to constitute a complete plan.

The system enables more than one content author to work on a single knowledgebase at the same time while updating data. Users cannot work on the same plan at the same time. If a user attempts to access a plan or employer that is already being modified by another user, then he/she is able to view the plan or employer but not modify it.

Users may “check out” plans or employers from the knowledgebase for authoring on a local computer. Once a plan is checked out, it cannot be modified by other users accessing the knowledgebase. If a user attempts to access a plan or employer that has been checked out by another user, then he/she may view the plan or employer but not modify it. When a user has finished authoring, he/she may “check in” the plan or employer back into the common

The system allows users to transfer plans, employers, and employer groups from one knowledgebase into another knowledgebase.

Auditing/Statistics Tracking

During a user interaction occurring through the browser, the system track two types of statistics: user and performance. User statistics enable a carrier to understand user behavior and evaluate its communication strategy. Performance statistics measure the application's ability to support a user population.

The system tools track user interaction and content changes through an audit log.

All statistics are stored in a ODBC compliant data source separate from the knowledgebase for ease of reporting. Users may access the information and create custom reports with standard third-party reporting tools.

Tracking user statistics will enable carriers to determine where employees have the most questions, evaluate the impact of different communication methods, and modify member communications accordingly. This information will also be used to track the number of unique sessions by role to support a variety of pricing strategies.

The system tracks the following information about each user interaction: Session date, Session start time, Referring site address (if applicable), Each page visited (can be combined with session start time to determine session length and hit frequency), Frequency with which a particular page is viewed, User characteristics (e.g., role, user demographic information), Search strings (i.e., actual keywords and concepts that users type in as search criteria), Number of hits yielded for a particular search string, Tracking methods and uses will comply with established standards (e.g., HIPAA) to ensure security and user privacy.

Tracking performance statistics measure the system's ability to support a given user population within a particular implementation environment. These figures will help to identify the source of any potential performance problems. The system tracks the following performance data during each user interaction: Login/authentication duration, Contracting/claims system duration (i.e., time it takes to pull in member demographic and eligibility data), Page generation duration, Search duration.

The system tools keep an audit log of all changes made to content within the knowledgebase. For any data addition or modification, the audit log records the user ID, date and time, name of field changed, and current field value. Users may not delete any part of the audit log.

The system enables carriers to manually or automatically archive portions of the tracking data source. Archiving allows carriers to retain access to historical data without having to maintain and manage a potentially overwhelming amount of data.

Members may not be able to find the information they need from the system web site alone. The system will support members by providing access to additional resources within the carrier organization through email and callback requests.

Members may email member services at the carrier organization directly from each the system page displayed in the browser. Once completed, a popup confirmation message confirms that the email has been sent.

Members may request that a CSR or other member services representative call them back by telephone. They may make the request directly from each system page displayed in the browser. Once completed, a popup confirmation message confirms that the request has been sent.

Members may request an interactive, web-based “chat” with a CSR or other member services representative. They may make the request directly from each the system page displayed in the browser. Once the request has been processed, an online CSR may interact with the member real-time.

Carriers may attach electronic forms (e.g., MS Word or Adobe Acrobat formats) to the system pages for access by members. They may provide forms for functions such as updating demographic information, filing a claim, changing providers, collecting health status data, enrolling dependents, requesting referrals, or measuring member satisfaction.

Members can view forms directly from the system pages. They may also print out the form or email it to the carrier, again directly from the product.

Carriers can customize the look and feel of the system pages in two ways. They may customize the standard page style sheets and layouts or they may publish the system content and components in the pages of other carrier web environments.

Members and CSRs may search for information through search controls available on every the system page. The user will type in keywords or concepts to describe what he/she is looking for and receive in return a list of associated search results. The system will support the use of everyday language as search criteria by considering keywords, synonyms, word stems, and noise words in its interpretation of the search request.

By default, a request will search the entire the system web site. Users may limit the scope of a search to a particular plan.

Generate Reports

The system will enable healthcare insurers to generate reports on the statistics tracked by the application and on the audit log. They may use standard third-party reporting tools to create the reports. The system may provide standard reports, but at a minimum allows carriers to create custom reports from the statistics data source. Specific reporting requirements for any standard reports are to be determined.

The system will also generate verification reports for content authors and implementers. These reports will represent HTML and printed representations of what a generated page will look like from the end-user perspective.

Among the benefit areas that may be covered by plans in the system are Medical, COBRA administration, HIPAA administration, Dental, Vision/hearing, Health care/Dependent care flexible spending account, Life events, Long term care, Long term disability, Life insurance, Life insurance including Group Universal Life, Dependent Life, AD&D, and Business Travel & Accident. Short term disability including Executive life, Individual insurance, Auto/homeowners, Umbrella liability, financial products such as 401(K), other retirement savings account, and college savings accounts.

Security

CSRs can be restricted to particular employer groups or particular plans based on the identity of the CSR (determined at login). If a CSR is restricted to a particular plan or employer, then he/she will only be able to view information about that plan or employer.

Members are restricted to personal information about themselves or their dependents. They have full access to generic plan information.

Users are assigned permissions to use particular tools and perform specific tasks within the tools. For example, a user may be able to modify existing plan variables, while not being able to create new variables.

The system uses standard communications security structures to protect data as it is being transmitted over the Internet.

Any member specific data in the system is encrypted (e.g., session state, user ID).

Call tracking

Call Tracking/CRM systems are used to document the interaction between a member and member services at the healthcare organization. Example call tracking/CRM system vendors include Quintus (www.quintus.com), Remedy (www.remedy.com), and Siebel (www.siebel.com). Some call tracking applications can use client-side integration, but others require server-side integration.

In an integrated environment, CSRs may login only once for both applications, initiate a search in the call tracking application and be brought to the appropriate place within the system, and to log answers/text from the system into a call tracking application.

Combined Carrier/Employer System

A carrier-based system can be combined with an employer-based system to produce useful results, especially because the target for communication is the same person, acting as either employee or member. Combining the employer specific information with detailed plan information in the system provides the employee/member with a central source for policy and plan information. The member receives consistent information all in one place, the employer provides employees with better service, and carriers have a place on the employer desktop enabling them to provide better service and develop a stronger relationship with the employee/member.

### INSURANCE CARRIER EXAMPLE

In a specific example of the system shown in FIG. 1, the aggregators are employers, the customers are employees and the products are insurance policies or plans that provide benefits to eligible employees based on conditions that arise during the plan period. The insurance policies and plans may be offered by carriers (the producers) through the agents and brokers, and then through the employers, to the employees.

Often, the employer gives its employees choices of benefits and makes available, for example, different health insurance plans underwritten by different carriers as options for the heath insurance component of the benefits program. The employees typically need information about the plans at two different times: when they are choosing between available options prior to the beginning of the plan period, and, after the choice has been made, when particular personal situations or life events occur during the plan period.

When making choices among available options, the employees need explanations of the comparative features of the available plans and may have questions and may wish to analyze the costs and benefits of the available choices with respect to their personal situations or life events.

Once the choices are made and the policies are in effect, the employees often have questions about coverage, deductibles, and co-payments, for example, with respect to personal health conditions.

To serve the market, the may carriers offer a wide variety of different health insurance policies and versions of policies, often custom tailored to the needs of each of their customers (the employers) and to the interests and needs of the employees who will become the members.

The market for insurance products as between employers and carriers is defined by requests for proposals or requests for information from employers and proposals or information by carriers about products that are configured to meet the requests. Agents and brokers play a role in the market in passing information, creating proposals and responses and using information that is stored in the repository and server.

Product Templates

The product characteristics 22 can be expressed and stored in accordance with a common language or standardized product-description format. The product characteristics can include eligibility requirements, plan periods, costs, benefits, covered conditions, co-payments, deductibles, and conditions for coverage.

The common language enables the features of a wide variety of health insurance products to be captured easily and conveyed easily to employees and others in the supply chain at each stage in the distribution of the product. The stages can include the creation of products by carriers, the purchase and sale of the products between the carriers and the employers through the agents and brokers, the presentation of the products to employees, and the response to requests for information by employees and others in the supply chain both before and after the product has been sold. The common language enables the raw materials (information about the plan features) that are needed for a variety of expressions of the product characteristics to be derived easily and embedded in appropriate materials for dissemination to people who need them.

As shown in FIG. 2, the common language enables the product characteristics of different health insurance products to be expressed as templates 50. Each of the templates contains rules of the kind “if conditions x exist, then result y obtains” for the related insurance product. For example, one rule might be: “if dependent age [here dependent age will be a variable that will be dynamically populated with member information from a carrier's HCIS system] is greater than 21, then the mental health coverage does not apply.”

In one software implementation, the templates (which can also be called knowledge blocks to refer to the knowledge base content of the templates) can be software objects that are organized hierarchically so that a root template contains rules that generally characterize health care policies. Each template in the hierarchy inherits the rules from its ancestor templates at higher levels in the hierarchy up to the root template.

In another approach, each template stands on its own in a nonhierarchical arrangement. A new template can be created by copying an existing one and then modifying the copy, but without requiring enforcement of inheritance in the usual sense.

In any case, the use of a common language for expressing the templates enables all of the parties to the supply chain to easily create and use commonly expressed templates to capture the characteristics of the products for later use. Applications that create or use the templates can easily generate, use, and compare different products. For example, an application that generates plan descriptions for employee use can be written to automatically derive the needed information from the templates with some assurance that as carriers add new products or as new carriers being to offer products, the application will not have to be rewritten. In effect, the templates provide a medium of exchange of product information for all of the parties in the supply chain.

By storing the product templates for multiple carriers on a single set of repositories and servers, the value of applications that generate and use the templates is enhanced. One trusted party can become the intermediary that receives, stores, and makes available the templates to all parties in the supply chain from a common set of repositories and servers. The trusted party need not be any of the parties that are in the supply chain. Generating information for the repository and server

The templates are created by content authors 32. In some examples, the content authors are affiliated with the carriers. In other examples, the content authors can be associated with a party who maintains the repository or server or with the agents or brokers or with other parties. When employers are proposing to the carriers possible insurance products of interest to the employers, the content authors could be associated with the employers.

The content authors create generalized templates to describe classes of insurance products.

Templates for specific products are created from the generalized templates by data gatherers 36. The information about specific products is represented by product parameters that form part of the template. For example, a generalized template might include a rule that “If the covered person is treated in a local hospital, the co-payment amount is Q.” This template could apply to a wide range possible insurance products. When a data gatherer creates a specific plan template (say a template for an Onyx Insurance policy to be made available to employees of Pyramid Internet Service), the data gatherer would include in the template a value of, say, $25 for the variable Q, so that the rule in the new specific template would become “If the covered person is treated at a local hospital, the co-payment amount is $25.”

The data gatherers may be affiliated with carriers, agents, brokers, or employers, depending on the purpose for which the specific template with product parameters is being created.

The data gathering engine 34 provides a user interface and application routines that enable a data gatherer to create a template and populate it with product parameters. The development engine 30 provides a user interface that enables content authors to create high-level general product templates.

Templates under development can be stored in the repository and server separately from templates that are finished and ready for use.

Providing Information and Answering Questions using the System

In one example, when the system shown in FIG. 1 is in active use (at run time), any party who is authorized to access it, can logon from a web browser or other user interface from any location through the Internet 44 to the query engine of the repository and server.

The query engine serves web pages to the users that provide a user interface in which questions can be asked, searches can be done, and information can be obtained. The user's interaction with the interface produces web requests that pass to the server 20. In response to a request, the query engine uses the templates, the customer information (for example, enrolled plan information), and other data (such as the current date, or the location of a particular hospital), to generate a responsive webpage. The page is served back to the browser.

Technical Architecture

FIG. 3 shows a runtime view of an example of a system of the kind shown in FIG. 1 that could be made available in particular to carriers in a hosted model. In this example, the templates can be considered a knowledge base that is part of a runtime system 100 that may be hosted by the carrier or by another party.

Employees (called members with respect to the carriers; members could be employees of a company or could be any other subscriber or dependent of a subscriber of an insurance plan) access the content of the knowledge base using a web browser through the Internet or an intranet of the carrier. The member can follow links to and from other sites from the site that serves the insurance information.

Customer service representatives (CSRs) in call centers also access the knowledgebase using a browser 102 through the Internet or intranet. CSRs are also be able to navigate into the knowledge base using links from a call tracking system such as Quintus or Remedy and are able to log answers back into the call tracking system.

The runtime system 100 is linked through a dedicated bridge over a secure network connection to the carrier's legacy health care information system (HCIS) 106 or locally through a bridge to an extract of the HCIS system 108.

To enable the runtime system to be used by a variety of parties, the system is built to provide multi-platform support and scalability in the face of high traffic and large volumes of data.

The system is designed to support up to 5,000 employers and 20,000 plans in a single knowledgebase. Components of the system can be distributed over multiple processes and machines through a lightweight, component-based system architecture.

Information in the authoring knowledge base is published to a runtime published database. Publishing is a process in which the knowledge base is preprocessed to optimize it for quick retrieval and display. The published database contains only information needed by the runtime system in an optimized format. The publishing step also allows some of the computation that would normally need to happen at runtime (such as data inheritance) to be done once during publishing instead of many times at runtime.

Among the effects of publishing of a knowledge block are that: (1). special “whenvisible” information is pre-evaluated, (2) the text descriptions of the block are transformed to XML data, (3) the block is transformed into Java code, with the rules translated to Java conditional logic, and (4) the Java code gets compiled into loadable classes and stored into database tables optimized for fast retrieval.

Publishing of the variables first resolves data inheritance and “whenvisible” evaluation. The transformed variable data is also stored into database tables optimized for fast retrieval. An example of a schema of published knowledge blocks is shown in FIGS. 15A, 15B, and 15C.

The implementation of the system can be based on the Java 2, Enterprise Edition™ platform to meet multi-platform requirements, increase scalability, and reduce development costs. Presentation content can be authored using Java Server Pages and Servlets. Other server components can be built as java packages or Enterprise Java Beans. Data access can be through JDBC.

In the runtime system, a hardware load-balanced cluster of web servers handles HTTP requests from browsers.

The presentation code that generates the web pages to be served back to the browsers in response to the requests needs access to core application services. The core application services include a knowledgebase runtime interpreter (e.g., the query engine of FIG. 1), which produces personalized XML output based on knowledgebase content. The core application services also include a search component, which allows searching of the knowledgebase content. These services can be implemented as enterprise java beans (EJB).

The presentation and core (EJB) code accesses database content through JDBC (including the legacy HCIS database and the published knowledgebase.) Queries and updates to the published knowledgebase are wrapped in stored procedures, which allow the schema to be modified and tuned for performance with minimal impact to the application code. Data update

The knowledgebase is hosted at a third party other than the carrier and a web-based, multi-user data gathering tool (the data gathering engine of FIG. 1) enables a large number of plans and employers to be handled by the knowledge base.

As shown in FIG. 4, the data gathering tool is hosted at the third party 120 and allows secure web-based access by core content creators and data gatherers (called implementers in the figure) working for the third party 122 and/or the carrier 124. They operate on an authoring schema 126 rather than on the published schema 128, 130.

At intervals during the data gathering/maintenance process, implementers preview their changes in a staging environment 128 that is identical (at least in terms of the way that information is presented in the browser) to the production system 130.

Implementers publish 132 the changed content to a staging server and access a scaled-down version of the runtime system 134 from their browsers. Implementers may capture and store comments in the system as part of their review processes. These comments may be accessed by other implementers and/or reviewers as well. These other implementers may add their own comments, either as independent notes or as notes attached to an existing comment.

Once the implementers are confident that their changes are correct, they initiate a move 136 of the published data to the production servers. Operationally, the move of the published data to the production servers can be performed by a third party that hosts the server. The actual move can be performed in response to a request for publication submitted to the third party. The request is put into a queue and is performed according to a predetermined/scheduled operating procedure.

Once the updated, published knowledgebase has been moved into the production environment, the changes are visible to all users of the system who have access rights to the particular published data.

Runtime Architecture

The system may be offered as a hosted, subscription-based service.

The operating environment from a carrier perspective includes a web browser.

The system components could use the following software: In the web server, Microsoft IIS, Netscape Enterprise Server, or Apache. For an operating system, Microsoft Windows NT 4.0 with SP5 or higher, or Microsoft Windows 2000, or Sun Solaris. For a database, Microsoft SQL Server 6.5 or higher, Oracle 8.x or higher.

As shown in FIG. 5, the runtime environment has three parts: the presentation layer (JSP and Servlets) 150, the EJB layer (Enterprise Java Beans) 152, and common components (accessible from any other layer) 154.

The presentation and EJB layers communicate with each other using the EJB interfaces, generally passing XML back and forth. The component layer and the presentation and EJB layers communicate with each other using java method calls (again, generally passing data in XML format.)

User session information is persisted across server clusters via Weblogic's in memory replication. User authentication and access rights information can be stored and queried directly from a local database or remotely from the carrier site.

The Enterprise Java Beans will generally be stateless session beans, because that model allows the greatest scalability and flexibility in clustering.

Common components 154 are implemented as java packages, and are accessible from either of the other layers.

The presentation layer 150 serves JSP pages 156 in response to web requests 158 from users. The presentation layer provides presentation services 160, authentication services 162, and call tracking integration. Requests for information are forwarded using XML over EJB interfaces to the EJB layer. The EJB layer provides the runtime interpreter services 164 which loads and executes the requested block information (compiled Java classes) from the published knowledgebase 130 via JDBC calls 166. The EJB layer also provides search services 168 through an API 170 to a Verity full-text search system. The Verity search system queries a pregenerated index database (metadata database 172) to return answers to the search questions performed.

The common components include logging/statistics/auditing components 174, which maintain log files 176 or store information directly in the database, session management components 176, authorization checking components 178 that interact with a user directory 178 and a policy store 180, and bridge components 182 that interact with the HCIS bridge and with the published knowledge base.

The process of run-time page generation is shown in FIG. 5. The sequence of operations is indicated by the numbers in parentheses in the figure. An incoming web request 190 reaches the entry point routine 192. Authentication is performed using security information 194. Page definitions are loaded using the published knowledgebase 130. A context is created for the query using the session manager 196. Information associated with the user is fetched from the HCIS system, and imported into the knowledgebase for use in generating a response. The output of the query process is generated as XML using an RTI service 206.

If the user requested a search, the search is executed and the results are obtained from the search service 198. The results of the search or of the query to the knowledgebase are provided to the page generator 200 in XML format. An XSLT processor 202 converts it to HTML and the resulting page is served back to the user.

### USER INTERFACES

Examples of pages of the user interface that are exposed to members in a health insurance implementation are shown in FIGS. 7 through 13.

FIG. 7 shows a home page 201. The page identifies the date 200 as of which the plan information is current, reflecting the fact that the system typically must track the time periods to which a given plan applies. The page also is personalized with the plan name and address of the member 202, 204. Links are provided that enable the member to see a plan summary 206, to test the effect of certain life events 208, and to change information about the member 210. A box 212 provides a space for the member to enter a query that will result in a search at the server.

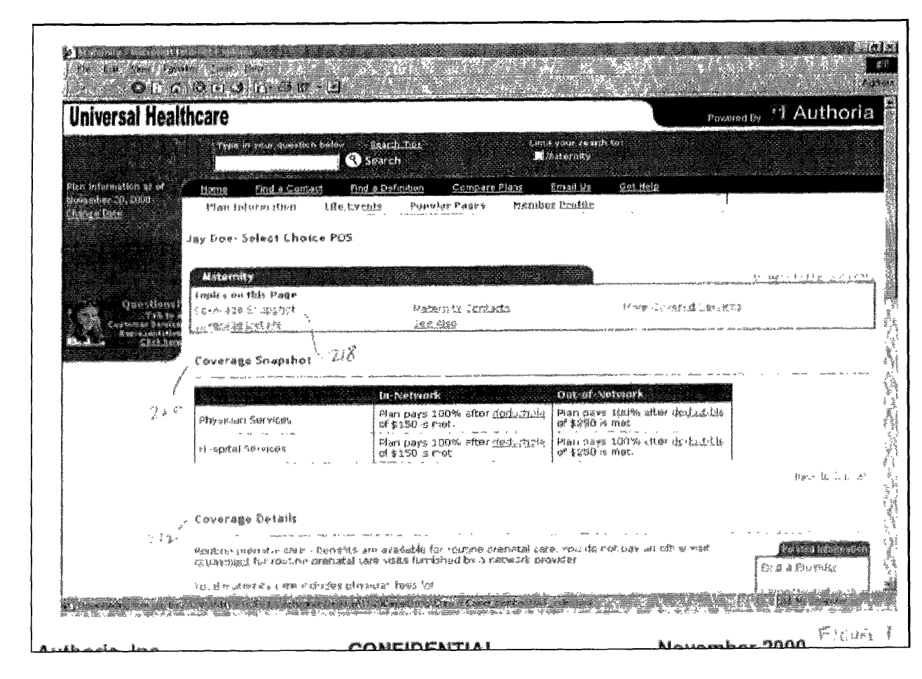

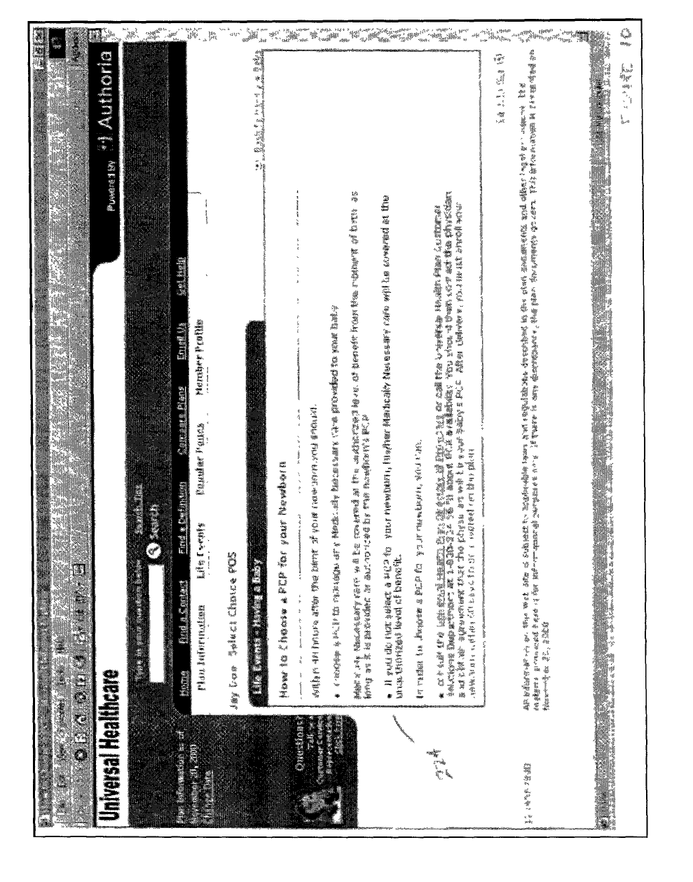

When the member chooses to see the plan summary page, FIG. 8 is presented. A plan summary 214 is provided in text form. The summary provides links 216 to an overview, a benefit summary, covered services, filing a claim, plan contacts, and how the plan works. The text of the plan summary is generated at the server using the plan templates stored there.

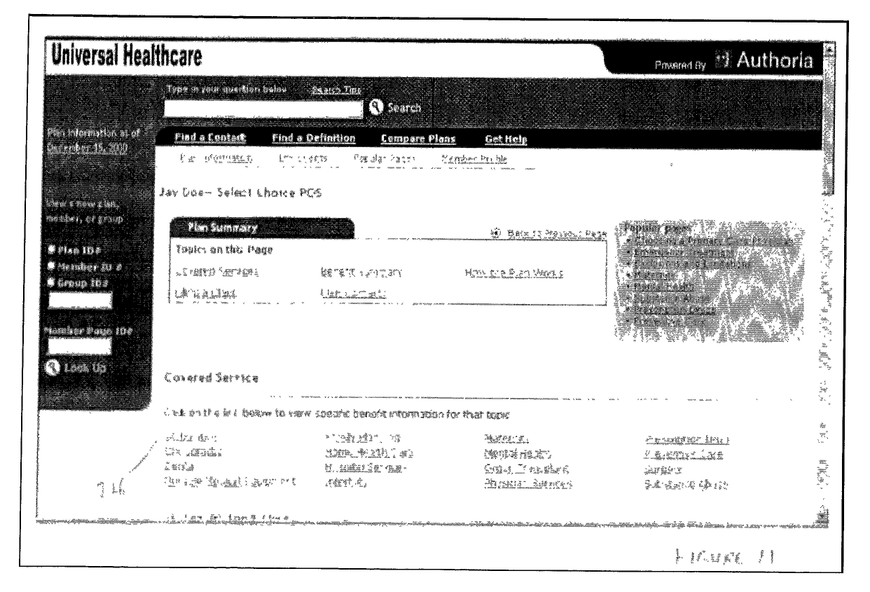

If the member invokes the covered services link, the page shown in FIG. 9 is presented. In this instance, page includes information on maternity coverage. Again, links 218 are provided to enable navigation to a lower level of detail on several topics. One of the links leads to a coverage snapshot 220 that defines the in-network and out-or-network coverage, with links 222 to obtain additional information about the deductible amounts. The next section discusses coverage details and includes a link to information about co-payment amount. The hierarchy of the information that is to be displayed is determined by the core content developer when the plan templates are created. The substance of the text that is displayed is also derived from the templates.

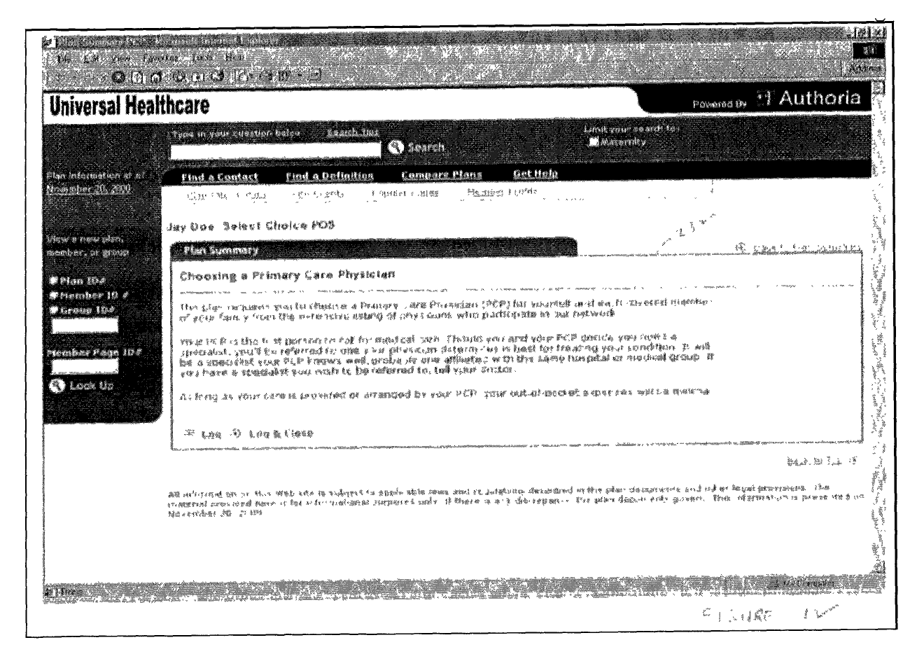

FIG. 10 shows one of the screens to which a member may navigate using in the life events section of the hierarchy. In this example, information 224 is provided about having a baby. The information describes coverage and gives instructions on how to proceed, including appropriate links.

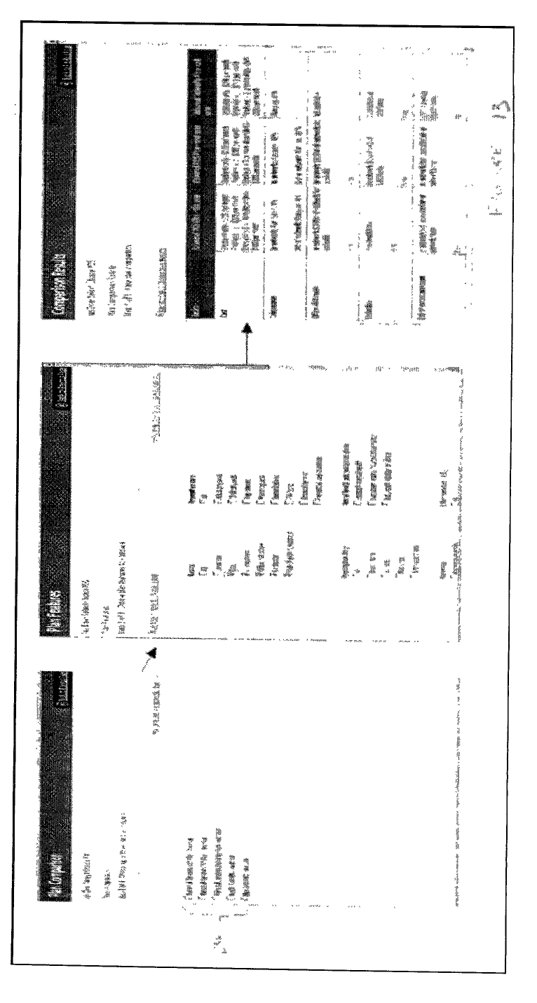

When “covered services” is invoked on FIG. 8, the page of FIG. 11 is displayed. A list of covered service links 226 enables the member to get specific information about coverage of particular situations.

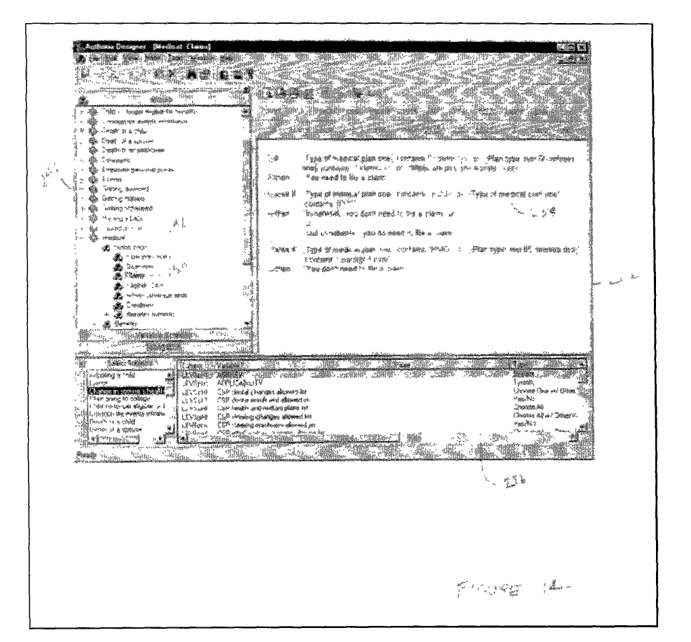

FIG. 12 is the page that is presented when one of the supplemental topics is invoked using the link 230 in FIG. 7. In this case, text 232 presents information about how to choose a primary care physician.

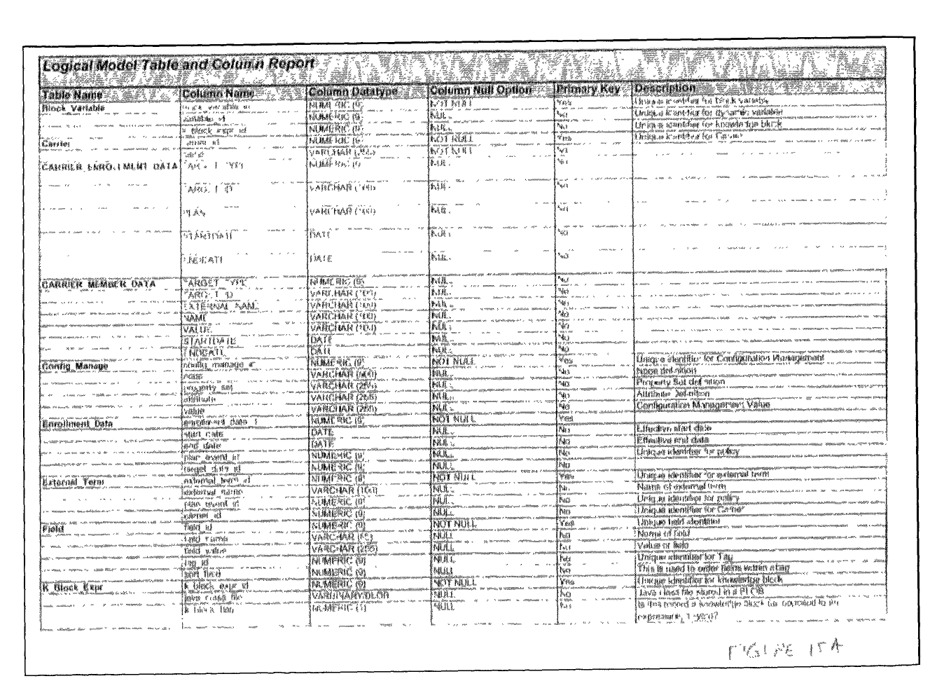

FIG. 13 shows three steps in navigating the system to obtain comparison information about different plans. In the screen shown on the left side of FIG. 13, the user can use checkboxes to select among different plans each identified by a name and a year 236. The next screen, shown in the middle of FIG. 13, enables the user to select features to be considered, such as features related to preventive care 238 and prescription drugs 240. After the selection of features has been made, the user is shown the screen at the right side of FIG. 13, which lists the selected features down the left side of a table 242 and the plans along the top 244. Each cell describes the plan's characteristics with respect to that feature. The information for the screens of FIG. 13 is drawn from the templates stored on the server.

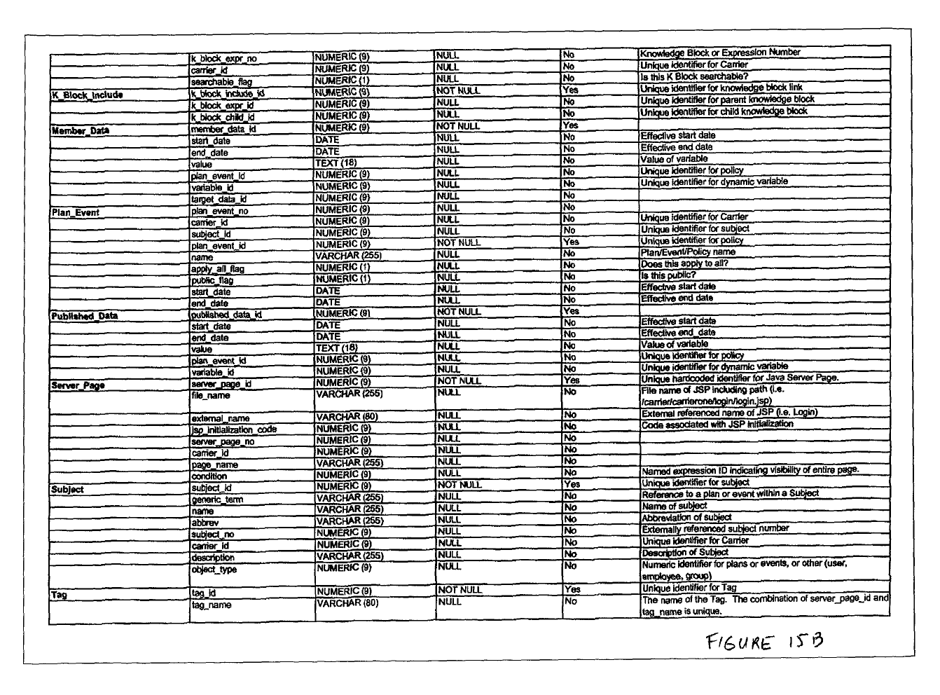

FIG. 14 shows an example of an interface page used by a core content creator in creating a template (knowledge block). A window 246 on the left side of the screen displays the hierarchy of the knowledge blocks as a navigational aid to finding and fetching a block to be reviewed or worked on. For example, the hierarchy for the medical block 248 is shown partially expanded. The first level of the hierarchy is the home page. Under the home page are listed several knowledge blocks including claims 250.

Window 252 displays the formal expression of the rule that is associated with the claims block. Each line of the rule contains a portion of the logical sequence of the rule. For example, line 254 expresses the condition that the “type of medical plan one” is either “POS” or “PPO” and line 256 provides the predicate that the coverage is either in plan or out of plan and the claim form either need not be filed or must be filed. In this example, “type of medical plan one” is a parameter or variable. “POS” and “PPO” are values for the variable.

To reduce the effort required of the content developer to create the knowledge blocks, possible variables are listed in a window 254 and can be added to the statement of the rule by clicking.

Other implementations are within the scope of the following claims.

For example, the system could be provided as an enhancement to an existing legacy HCIS system or as an enhancement to an existing health information web portal.

1. A method comprising
enabling an insurance carrier to create and maintain, on a server, product information that characterizes insurance products that are distributed by the insurance carrier through an employer to employees,
enabling retrieval at the server of employee information about the employees that is under control of the employer or the carrier, and
enabling individuals who are members with respect to the products of the insurance carrier to access the server to obtain answers to questions based on the product information and the employee information.

2. The method of claim 1 in which the server is hosted by a party other than the insurance carrier.

3. The method of claim 1 in which access to the server by the employees is through web browsers and a TCP/IP network.

4. The method of claim 1 in which the insurance carrier creates and maintains the product information through web browsers and a TCP/IP network.

5. The method of claim 1 in which the carrier is in control of carrier specific content information and plan details stored on the server.

6. The method of claim 1 in which the product information includes “if, then” rules that define general characteristics of the product and parameter values that render the rules specific to respective products.

7. The method of claim 1 in which the enabling of the insurance carrier to create and maintain the product information includes providing an interactive interface that prompts the carrier for parameter values required by product templates.

8. The method of claim 1 in which the enabling of the employees to access the server includes providing an interactive interface that enables the employees to express questions and have answers displayed.

9. The method of claim 8 in which the answers include information useful to the employee in making a choice among different insurance products.

10. The method of claim 8 in which the answers include information useful to the employee in determining the availability of coverage in a particular situation.

11. The method of claim 8 in which the questions are expressed in standardized formats and the answers are provided in standardized formats.

12. The method of claim 8 in which the questions comprise keywords and the answers comprise the results of using the keywords to search stored information accessible through the server.

13. The method of claim 1 in which the stored information about the employees includes demographic information.

14. A method comprising
during a development phase, creating and storing template information that characterizes types of insurance products,
during a publication phase, pre-processing the template information to create a published body of information about the types of insurance products and storing the published body of information in a server, the published body of information being configured to require less processing than the template information to respond to questions, and
during a run-time phase, applying questions received at the server about the insurance products to the published body of information to generate answers to the questions.

15. The method of claim 14 in which the questions received at the server relate to coverage of the insurance products with respect to particular situations of individuals who are members with respect to the products.

16. The method of claim 14 in which the answers are generated with reference to stored information about particular individuals who are members with respect to the insurance products.

17. A medium on which is stored a machine-readable representation of a product,
the product including conditional obligations of one party to another,
the representation of the product being stored in accordance with a standardized format for expression of characteristics of the product, the characteristics including conditions under which a party would be eligible to obtain the product and conditions under which a party that has obtained the product is entitled to receive the benefit of the obligations included in the product,
the representation of the product implying an interface that enables applications to create, maintain, and access the representation of the product for predefined purposes.

18. The medium of claim 17 in which the obligations included in the product comprise benefits for individuals.

19. The medium of claim 18 in which the benefits comprise insurance benefits or financial services benefits.

20. The medium of claim 17 in which the obligations comprise coverage obligations of an insurance carrier, and the party to whom the obligations are owed includes employees of an employer that offers the product of the carrier to the employees.

21. The medium of claim 17 in which the representation of the product comprises a general representation for a class of products and the conditions are defined in terms of variables.

22. The medium of claim 17 on which are also stored representations of other products that include obligations of one party to another.

23. The medium of claim 17 on which are also stored representations of products of competing parties, each of the products including obligations of one party to another, all of the representations being stored in accordance with the standardized format for expression of characteristics of the product.

24. A method comprising
enabling parties that belong to a supply chain for products to create product definitions for each of the products in accordance with a standardized product-definition format, the products being of a kind that encompass conditional obligations of suppliers of the products,
enabling each of the parties that create product definitions to store the product definitions in a manner that makes them accessible to at least one of the other parties in the supply chain, and
giving access to at least one of the parties in the supply chain to the stored product definitions in connection with a commercial transaction.

25. The method of claim 24 in which the conditional obligations comprise benefits to which individual members are entitled under insurance products upon the occurrence of predefined conditions, and the parties that belong to the supply chain include carriers and employers.

26. The method of claim 25 in which the standardized product-definition format associates benefits with conditions that trigger entitlement to the benefits.

27. The method of claim 25 in which the standardized product-definition format associates the product with conditions on the availability of the product to potential members.

28. The method of claim 24 in which the product definitions are stored on a common server that is accessible to the parties in the supply chain through a public network.

29. The method of claim 24 also including generating information about the products for use by parties that belong to the supply chain using the stored product definitions.

30. The method of claim 29 in which the generated information is configured based on the party that will be using it.

31. The method of claim 24 also including giving parties that are not in the supply chain access to information derived from the product definitions.

32. The method of claim 31 in which the parties are end users of the products.

33. The method of claim 24 also including
one of the parties in the supply chain making a commercial proposal to another of the parties in the supply chain with respect to one of the products by referring to the stored definition of the product.

34. The method of claim 33 in which the proposal comprises a request for proposals, a request for information, or a reply to a request for proposals or to a request for information.

35. The method of claim 24 also including
enabling one of the parties in the supply chain to provide automated answers and information about the product to end customers of the product using the stored product definitions.

36. A method comprising
from a server, enabling an employee of an employer to get answers to questions that relate to characteristics of an insurance product of a carrier with respect to which the employee is or may become a member,
analyzing the employee's interaction with the server,
based on the analysis and on information known to the employer about the employee, determining other insurance products of the carrier that may be of interest to the employee, and
providing information about the other products to the employee in conjunction with providing answers to the questions of the employee.

37. The method of claim 36 also including
storing information about the product and the other products on the server in a standardized format, and
querying the stored information to generate the answers to the questions.

38. The method of claim 37 also including enabling the carrier to store the information about the products and other products in the server without intervention by the employer.

39. The method of claim 38 in which the information known to the employer about the employee is accessed by the server from a legacy system of the employer.

40. The method of claim 38 in which the information is accessible by the server from a legacy system of the carrier.

41. A system comprising
a knowledgebase of information about products that represent conditional obligations of a supplier of the products,
an evaluation layer that evaluates information in the knowledgebase in response to requests from a presentation layer,
the presentation layer being configured to respond to queries received from a publicly accessible communication network, and
a components layer configured to manage sessions with users from whom the queries are received.

42. The system of claim 41 in which the presentation layer is configured to compose and serve web pages in response to the queries, based on the evaluation performed by the evaluation layer.

43. The system of claim 41 in which the presentation layer is configured apply security measures.

44. The system of claim 41 in which the presentation layer communicates with the evaluation layer using XML over java beans.

45. The system of claim 41 in which the evaluation layer is also configured to search a database based on the query.

46. The system of claim 41 in which the components layer is also configured to perform logging, statistics, and audit functions.

47. The system of claim 41 in which the components layer is also configured to provide a bridge to a legacy database of information about users.

48. The system of claim 41 in which the components layer comprises software components.

49. The system of claim 41 in which the evaluation layer comprises a run-time interpreter.

50. A system comprising
access to a legacy health care information system, and
enhancements to the legacy health care information system that
enable an insurance carrier to create and maintain product information that characterizes insurance products that are distributed by the insurance carrier through the employer to employees,
enable retrieval of employee information about the employees from the legacy system, and
enable employees who are members with respect to the products of the insurance carrier to obtain answers to questions based on the product information and the employee information.

51. A system comprising
a web portal that makes health care information available to the public through the Internet, and
enhancements to the web portal that
enable an insurance carrier to create and maintain product information that characterizes insurance products that are distributed by the insurance carrier, and
enable employees who are members with respect to the products of the insurance carrier to obtain answers to questions based on the product information.

52. A method comprising
enabling an benefits provider or a financial institution to create and maintain, on a server, product information that characterizes products that are distributed by the provider or institution to individuals,
enabling retrieval at the server of information about the individuals that is under control of the provider or institution or a third party, and
enabling individuals who are members with respect to the products of the provider or institution to access the server to obtain answers to questions based on the product information and the information about the individuals.
